(19) United States
(12) Patent Application Publication
(10) Pub. No.: US 2026/0141713 A1
(43) Pub. Date: May 21, 2026

(54) METHOD AND APPARATUS FOR DETECTING OBJECT BASED ON PARALLEL CONNECTION OF COOPERATIVE PERCEPTION MODULE

(71) Applicant: Korea Advanced Institute of Science and Technology, Daejeon (KR)

(72) Inventors: Hee Jin AHN, Daejeon (KR); Hyun Chul BAE, Daejeon (KR); Min Hee KANG, Daejeon (KR)

(21) Appl. No.: 19/390,266

(22) Filed: Nov. 14, 2025

(30) Foreign Application Priority Data
Nov. 15, 2024 (KR) 10-2024-0163570

(51) Int. Cl. G06V 10/94; G06V 10/44; G06V 10/77; G06V 20/58

(52) U.S. Cl. CPC G06V 10/95; G06V 10/44; G06V 10/7715; G06V 20/58

(57) ABSTRACT

A method for detecting an object based on a parallel connection of cooperative perception modules according to an embodiment, the method comprises: obtaining feature data from an ego agent, surrounding agents of the ego agent, and surrounding infrastructure facility of the ego agent; and detecting the object in the ego agent based on a head that is output by inputting the feature data into a deep learning model designed based on the parallel connection of the cooperative perception modules.

### CROSS-REFERENCE TO RELATED APPLICATION

This application claims priority to Korean Patent Application No. 10-2024-0163570, filed on November 15, 2024, the entirety of which is incorporated herein by reference for all purposes.

### TECHNICAL FIELD

The present disclosure relates to a method and apparatus for object detection in a cooperative perception system, wherein a fusion module includes a plurality of functional blocks that are connected in parallel to extract diverse and complementary features.

This work was supported by Institute of Information & communications Technology Planning & Evaluation (IITP) grant funded by the Korea government (Ministry of Science and ICT) (Project unique No.: RS-2023-00259991; Project No.: N01240048; R&D project: Information and Communication Broadcasting Innovation Talent Development Project; Research Project Title: Development of core convergence technologies for AI, communications, and sensing for future mobility services; and Project period: 2024.01.01. ~ 2024.12.31.)

### BACKGROUND

For the popularization of autonomous driving services, research on autonomous driving technology in urban areas is being actively conducted, but with the current level of autonomous driving technology, there is a difficulty in providing autonomous driving services in urban areas where a large number of vehicles are concentrated.

From the perspective of perception technology, which is one of the main technologies of autonomous driving, the main reasons for this are occlusion caused by surrounding agents and road obstacles, and inaccurate recognition of surrounding objects in a narrow area due to a limited sensor measurement range.

To address such problems, a technology utilizing communication between a vehicle and another vehicle or road infrastructure, such as V2V (vehicle-to-vehicle) and V2X (vehicle-to-everything), has been proposed.

However, since such cooperative perception technologies require exchanging and processing large-scale information from multiple agents, the data size and model complexity significantly increase. Consequently, the demand for high-performance hardware resources, such as GPUs with large memory capacity, also rises, making it difficult to maintain model efficiency in real driving environments. Accordingly, there is a need for a cooperative perception technique that can enhance detection robustness while reducing model parameters and computational load.

In this regard, collaborative perception technologies using V2X communication, such as V2X-ViT, HM-ViT, and How2comm, have emerged, but they still suffer from large model sizes and high computational complexity, making it difficult to achieve model efficiency in real-world applications..

### SUMMARY

An object of an embodiment is to improve the efficiency and accuracy of object detection by employing a lightweight collaborative perception model in which multiple functional blocks within a fusion module are connected in parallel, thereby enhancing feature diversity while reducing model parameters and computational complexity.

However, the problems to be solved by the disclosed embodiments are not limited to those mentioned above, and other unmentioned problems will be clearly understood by those of ordinary skill in the art to which the present disclosure pertains from the following description.

A method for detecting an object based on a parallel connection of cooperative perception modules according to an embodiment, the method comprises: obtaining feature data from an ego agent, surrounding agents of the ego agent, and surrounding infrastructure facility of the ego agent; and detecting the object in the ego agent based on a head that is output by inputting the feature data into a deep learning model designed based on the parallel connection of the cooperative perception modules.

Herein, the obtaining the feature data may include: acquiring first feature data to third feature data, respectively corresponding to first LiDAR point cloud data, second LiDAR point cloud data, and third LiDAR point cloud data from each agent based on communication among a first agent of the ego agent, a second agent of the surrounding agents, and a third agent of the surrounding infrastructure facility; and determining the feature data for recognizing the object in the ego agent, based on sharing of the first feature data to the third feature data.

Furthermore, the deep learning model may include: a first cooperative perception module that identifies complementary information from features received from communication-capable agents; a second cooperative perception module for recognizing global information about a driving space; and a third cooperative perception module for recognizing local information about the driving space.

The first cooperative perception module, the second cooperative perception module, and the third cooperative perception module may be connected in parallel.

Furthermore, the detecting the object may include: outputting compressed feature data by inputting the feature data into a channel compression layer ; and outputting the head by parallelly inputting the compressed feature data into the first cooperative perception module, the second cooperative perception module, and the third cooperative perception module, wherein the outputting compressed feature data and the outputting the head are repeated for a predetermined number of iterations.

An apparatus for detecting an object based on a parallel connection of cooperative perception modules according to another embodiment, the apparatus comprises: a memory in which an object detection program is stored; and a processor that loads the object detection program from the memory and executes the object detection program, wherein the processor is configured to obtain feature data from an ego agent, surrounding agents of the ego agent, and surrounding infrastructure facility of the ego agent, and detect the object in the ego agent based on a head that is output by inputting the feature data into a deep learning model designed based on the parallel connection of the cooperative perception modules.

Herein, the processor may acquire first feature data to third feature data, respectively corresponding to first LiDAR point cloud data, second LiDAR point cloud data, and third LiDAR point cloud data from each agent based on communication among a first agent of the ego agent, a second agent of the surrounding agents, and a third agent of the surrounding infrastructure facility, and determine the feature data for recognizing the object in the ego agent, based on sharing of the first feature data to the third feature data.

Furthermore, the deep learning model may include: a first cooperative perception module that identifies complementary information from features received from communication-capable agents; a second cooperative perception module for recognizing global information about a driving space; and a third cooperative perception module for recognizing local information about the driving space.

The first cooperative perception module, the second cooperative perception module, and the third cooperative perception module may be connected in parallel.

Meanwhile, the processor may output compressed feature data by inputting the feature data into a channel compression layer , and output the head by parallelly inputting the compressed feature data into the first cooperative perception module, the second cooperative perception module, and the third cooperative perception module wherein the outputting compressed feature data and the outputting the head are repeated for a predetermined number of iterations. Specifically, the feature data is first processed through a channel compression layer, and the resulting compressed feature data is then fed in parallel into the first cooperative perception module, the second cooperative perception module, and the third cooperative perception module; this processing sequence is repeated for a predetermined number of iterations; and after completing the predetermined number of iterations, the final processed feature data is input to the detection head to generate the output.

A non-transitory computer-readable storage medium storing a computer program according to another embodiment may comprise instructions for causing the processor to perform an object detection method comprising: obtaining feature data from an ego agent, surrounding agents of the ego agent, and surrounding infrastructure facility of the ego agent; and detecting the object in the ego agent based on a head that is output by inputting the feature data into a deep learning model designed based on a parallel connection of cooperative perception modules.

According to the above aspects, the efficiency of object detection may be dramatically improved due to a reduction in model size and computational complexity, by using a lightweight deep learning model designed based on a parallel connection of cooperative perception modules.

Furthermore, according to the above aspects, the accuracy of object detection may be improved by using feature data obtained from various agents utilizing V2X communication. In particular, the according to the above aspects, strong noise robustness may be achieved, maintaining high detection accuracy even under environments affected by various types of noise such as communication delays and sensor noise. Such performance improvement may be attributed to the following factors: (1) by employing a parallel connection structure, the model is trained to generate mutually complementary representations from diverse deep learning models, and (2) even if one of the deep learning models is affected by noise, the parallel connection prevents the propagation of noise to the other models.

### BRIEF DESCRIPTION OF THE DRAWINGS

FIG. 1 is a block diagram illustrating an object detection apparatus according to an embodiment.

FIG. 2 is a block diagram conceptually illustrating the functions of an object detection program according to an embodiment.

FIG. 3 is a flowchart illustrating a method for detecting an object based on a parallel connection of cooperative perception modules according to an embodiment.

FIG. 4 is a diagram illustratively showing the feature data obtained using V2X communication according to an embodiment.

FIG. 5 is a diagram illustratively showing the output of a head using a deep learning model designed based on a parallel connection of cooperative perception modules according to an embodiment.

FIG. 6 is a diagram illustratively showing a comparison result of the performance of a deep learning model designed based on a parallel connection of cooperative perception modules according to an embodiment and the performance of a conventional deep learning model.

### DETAILED DESCRIPTION

The advantages and features of the disclosed embodiments and the methods for achieving them will become clear with reference to the embodiments described in detail below with the accompanying drawings. However, the invention is not limited to the embodiments disclosed below and may be implemented in various different forms; these embodiments are provided only to make the disclosure herein complete and to fully inform a person skilled in the art to which the disclosure pertains of the scope of the invention, and the invention is only defined by the scope of the claims.

In describing the embodiments, if it is determined that a detailed description of a known function or configuration may unnecessarily obscure the gist of the disclosure, the detailed description will be omitted. And the terms described below are terms defined in consideration of the functions in the embodiments of the present invention, and they may vary depending on the intention or custom of the user, operator, etc. Therefore, the definition should be made based on the content throughout this specification.

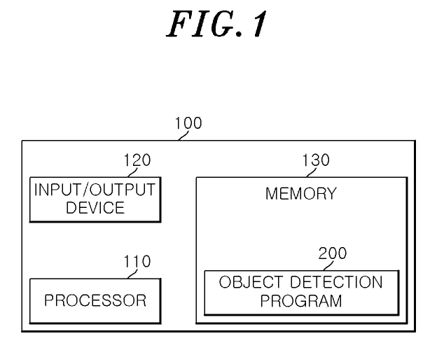

FIG. 1 is a block diagram illustrating an object detection apparatus according to an embodiment.

Referring to FIG. 1, the object detection apparatus 100 may comprise a processor 110, an input/output device 120, and a memory 130.

The processor 110 may control the overall operation of the object detection apparatus 100.

The processor 110 may receive feature data obtained from an ego agent, surrounding agents of the ego agent and surrounding infrastructure facility of the ego agent, using the input/output device 120.

In the present specification, although it is described that the feature data obtained from the ego agent, the surrounding agents of the ego agent, and the surrounding infrastructure facility of the ego agent is input through the input/output device 120, this is not intended to be limiting. That is, according to an embodiment, the object detection apparatus 100 may include a transceiver (not shown), and the object detection apparatus 100 may receive the feature data using the transceiver (not shown), and the feature data may be generated within the object detection apparatus 100.

The processor 110 may extract feature data from the sensing data obtained from the ego agent and may detect an object in the ego agent using a deep learning model designed based on a parallel connection of cooperative perception modules.

The input/output device 120 may include one or more input devices and/or one or more output devices. For example, the input devices may include a microphone, a keyboard, a mouse, a touch screen, or at least one of sensor devices such as a camera, radar or LiDAR, etc., and the output devices may include a display, a speaker, etc.

The memory 130 may store an object detection program 200 and information necessary for the execution of the object detection program 200.

In this specification, the object detection program 200 may refer to software including instructions for extracting feature data from sensing data obtained from an ego agent and detecting an object in the ego agent based on a head that is output by inputting the feature data into a deep learning model designed based on the parallel connection of cooperative perception modules.

The processor 110 may load the object detection program 200 and information necessary for the execution of the object detection program 200 from the memory 130 to execute the object detection program 200.

The processor 110, by executing the object detection program 200, may obtain feature data from an ego agent using the feature extractor of the ego agent. Herein, the processor 110, by executing the object detection program 200, may obtain feature data from surrounding agents of the ego agent, and surrounding infrastructure facility of the ego agent using V2X communication. The processor 110, by executing the object detection program 200, may detect an object in the ego agent based on a head that is output by inputting the feature data into a deep learning model designed based on the parallel connection of cooperative perception modules.

Herein, the sensing data may be data obtained from various sensor devices such as a camera, radar, LiDAR, etc., embedded in or attached to an ego agent, surrounding agents of the ego agent, and surrounding infrastructure facility of the ego agent, based on V2X communication, and may include, for example, data regarding a LiDAR point cloud, an object's pose, a timestamp, a type of surrounding agent or surrounding infrastructure facility, etc.

Herein, the feature data may be data obtained from an ego agent, surrounding agents of the ego agent, and surrounding infrastructure facility of the ego agent, based on the sensing data respectively required from the ego agent, the surrounding agents of the ego agent, and the surrounding infrastructure facility of the ego agent.

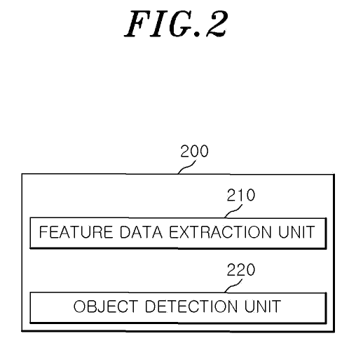

The functions and/or operations of the object detection program 200 will be examined in detail through FIG. 2.

FIG. 2 is a block diagram conceptually illustrating the functions of an object detection program according to an embodiment of the present invention.

Referring to FIG. 2, the object detection program 200 may comprise a feature data extraction unit 210 and an object detection unit 220.

The feature data extraction unit 210 and the object detection unit 220 shown in FIG. 2 are conceptual divisions of the functions of the object detection program 200 for ease of explanation of the functions of the object detection program 200, and are not limited thereto. According to embodiments, the functions of the feature data extraction unit 210 and the object detection unit 220 may be merged/separated and may be implemented as a series of instructions included in a single program.

First, the feature data extraction unit 210 may extract feature data from sensing data obtained from an ego agent. Herein, the feature data may be extracted from sensing data respectively obtained from surrounding agents of the ego agent, and surrounding infrastructure facility of the ego agent, and may be transmitted to the ego agent using V2X communication.

Specifically, the feature data extraction unit 210 may acquire respective feature data from each agent operating in the ego agent, surrounding agents, and surrounding infrastructure facility, using V2X communication.

Herein, the agent may be an entity participating in collaborative perception. For example, the agent may include a vehicle or intelligent infrastructure. Among them, an ego agent may be a central agent of the system performing an object-detection task, while an auxiliary agent may be an agent that assists the ego agent by sharing various information through communication.

Herein, the feature may refer to information generated by each agent through a feature extraction module. The feature may be shared through communication. Since the feature has a much smaller data size than raw sensing data, the feature may easily satisfy bandwidth requirements during inter-agent communication, while containing richer information than a single-agent detection result such as 3D bounding boxes.

Herein, the object may include an entity (e.g., a vehicle, pedestrian, bicycle or motorcycle, etc.) within a detection range that the ego agent intends to detect while performing an object-detection task.

In one embodiment, the feature data extraction unit 210 may acquire first LiDAR point cloud data, second LiDAR point cloud data, and third LiDAR point cloud data from each agent, respectively, based on communication among a first agent of the ego agent, a second agent of a surrounding agent, and a third agent of a surrounding infrastructure facility.

Furthermore, the feature data extraction unit 210 may extract respective feature data by inputting each of the acquired sensing data into a feature extraction module.

The feature extraction module according to one embodiment may comprise a PillarNet model for converting a point cloud into a 2D pseudo-image and a backbone model of ResNet for efficiently extracting features from an image.

In one embodiment, the feature data extraction unit 210 may extract first feature data to third feature data by inputting the first LiDAR point cloud data to the third LiDAR point cloud data into the feature extraction module.

In one embodiment, the feature data extraction unit 210 may determine feature data (e.g., a feature map) for recognizing an object in the ego agent, based on sharing of the first feature data to the third feature data.

Herein, feature sharing according to an embodiment of the present invention may be achieved by the first agent of the ego agent receiving respective feature data from the second agent of a surrounding agent or the third agent of a surrounding infrastructure facility through communication, transforming the feature data to be suitable for the coordinate system of the first agent, removing unnecessary data, and performing compensation according to a time delay.

In this way, by extracting feature data related to object recognition from feature data obtained from various agents and sharing it, the feature data may function as features for recognizing an object from various scales and various perspectives.

Meanwhile, the models, modules, or algorithms constituting the feature extraction module are only an example, and may be variously changed within a scope in which an object of an embodiment may be achieved.

Next, the object detection unit 220 may detect an object in the ego agent based on a head that is output by inputting the feature data into a deep learning model designed based on a parallel connection of cooperative perception modules.

The deep learning model according to an embodiment of the present invention may comprise a first cooperative perception module that identifies complementary information from features received from communication-capable agents, a second cooperative perception module for recognizing global information about a driving space, and a third cooperative perception module for recognizing local information about the driving space, and the first cooperative perception module, the second cooperative perception module, and the third cooperative perception module may be connected in parallel. Herein, first cooperative perception module may identify complementary information from other agents to compensate for the ego agent’s missing information.

Specifically, the first cooperative perception module according to one embodiment may refer to a module that, based on a self-attention algorithm, assigns higher weights to regions where the ego agent of a communication-capable auxiliary agent feature has difficulty performing object detection due to occlusion or sensor range limitations, thereby extracting global contextual information between communication-capable agents from the feature data. For example, the first cooperative perception module may include a known vanilla attention module.

Furthermore, the second cooperative perception module according to one embodiment may refer to a module that, based on a self-attention algorithm, extracts global contextual information about the driving space from the feature data by weighting observable information over a wide range that includes heterogeneous spaces (e.g., information regarding relationships between distant objects). For example, the second cooperative perception module may refer to a known DiNAT (dilated neighborhood attention transformer) model.

Furthermore, the third cooperative perception module according to one embodiment may refer to a module that, based on a CNN algorithm, extracts local information about the driving space from the feature data. For example, the third cooperative perception module may refer to a known ResNet model.

Meanwhile, the models or algorithms constituting the first cooperative perception module to the third cooperative perception module are only examples, and may be variously changed within a scope in which the object of an embodiment is achieved.

Specifically, the object detection unit 220 may extract compressed feature data by inputting the feature data into a channel compression layer.

Herein, the channel compression layer according to one embodiment may refer to a Fully-connected layer, and for example, the size of the compressed feature data passed through the channel compression layer may be about 1/4 of the size of the input feature data.

In accordance with an embodiment, the object detection unit 220 may detect an object in the ego agent according to the following steps.

1 collecting features of the ego agent and features received from surrounding objects,

2 inputting the collected features into a channel compression layer to compress the channel size to one-fourth (1/4),

3 inputting the compressed features into three different deep learning models, respectively,

4 concatenating the three output results of the three different deep learning models with the compressed features from step (2) along the channel dimension,

5 processing the concatenated features through a multi-layer perceptron (MLP) for additional feature refinement,

6 inputting the refined features back into the channel compression layer of step (2), and repeating steps (2) through (6) a predetermined number of times, and

7 inputting the refined features from the MLP into a detection head to perform 3D object detection at the final depth.

Herein, a head according to an embodiment of the present invention may refer to an output for recognizing, classifying, or detecting an object from the feature data (e.g., a feature map), such as a bounding box, a class, or a segmentation mask, or it may refer to a module that generates the output.

In this way, by compressing feature data through a channel compression layer and inputting the compressed feature data into a lightweight deep learning model that includes a plurality of cooperative perception modules connected in parallel, the compressed feature data may be provided to the plurality of cooperative perception modules, respectively, whereby a unique effect of improving the computational efficiency and accuracy of object detection in an ego agent may be achieved.

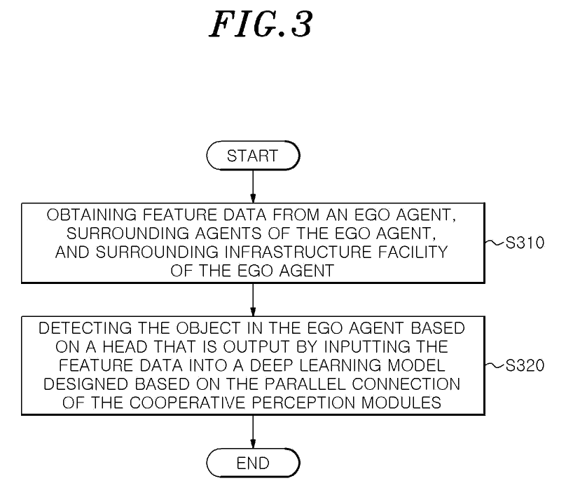

FIG. 3 is a flowchart illustrating a method for detecting an object based on a parallel connection of cooperative perception modules according to an embodiment of the present invention.

Referring to FIG. 3, the feature data extraction unit 210 may obtain feature data from an ego agent, surrounding agents of the ego agent, and surrounding infrastructure facility of the ego agent (S310). Herein, the ego agent may include ego vehicle and the surrounding agents may include surrounding vehicles.

Then, the object detection unit 220 may detect an object in the ego agent based on a head that is output by inputting the feature data into a deep learning model designed based on a parallel connection of cooperative perception modules (S320).

Herein, the deep learning model may include a first cooperative perception module that identifies complementary information from features received from communication-capable agents, a second cooperative perception module for recognizing global information about a driving space, and a third cooperative perception module for recognizing local information about a driving space.

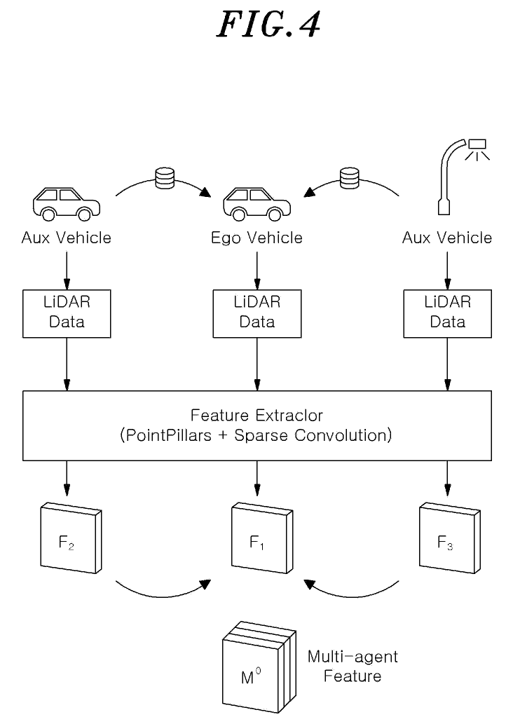

FIG. 4 is a diagram illustratively showing the feature data obtained using V2X communication according to an embodiment of the present invention.

Referring to FIG. 4, first LiDAR point cloud data to third LiDAR point cloud data may be respectively obtained from a first agent of an ego agent, a second agent of a surrounding agent, and a third agent of a surrounding infrastructure facility.

Then, first feature data (F1), second feature data (F2), and third feature data (F3) may be respectively extracted by inputting each of the first LiDAR point cloud data to the third LiDAR point cloud data into a feature extraction module.

Then, the feature data extraction unit 210 may extract a multi-agent feature corresponding to the feature data based on feature sharing of the first feature data (F1), the second feature data (F2), and the third feature data (F3).

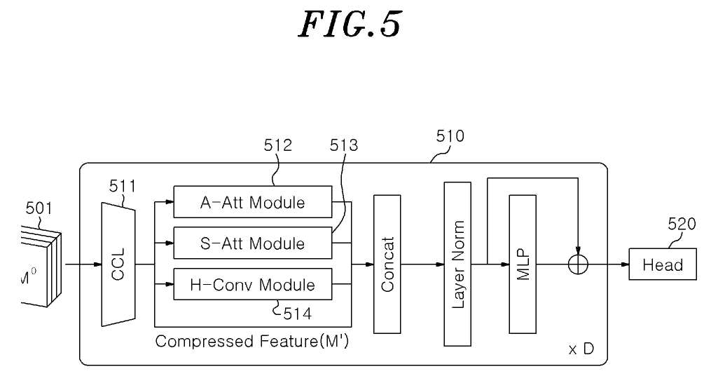

FIG. 5 is a diagram illustratively showing the output of a head using a deep learning model designed based on a parallel connection of cooperative perception modules according to an embodiment of the present invention.

Referring to FIG. 5, the object detection unit 220 may output a head 520 by inputting feature data 501 (i.e., a multi-agent feature) extracted by the feature data extraction unit 210 into a lightweight deep learning model 510.

Herein, the deep learning model 510 may include a channel compression layer 511, an A-Att Module 512 corresponding to the first cooperative perception module, an S-Att Module 513 corresponding to the second cooperative perception module, and an H-Conv Module 514 corresponding to the third cooperative perception module, and the A-Att Module 512, the S-Att Module 513, and the H-Conv Module 514 may have a structure connected in parallel.

Specifically, the object detection unit 220 may compress the feature data 501 to about 1/4 of its size by passing the feature data 501 through the channel compression layer 511.

Then, the object detection unit 220 may output a head 520 for detecting an object by inputting the compressed feature data into each of the A-Att Module 512, S-Att Module 513, and

H-Conv Module 514, combining the output data with the compressed feature data through a concat operation, normalizing it, and then passing it through an MLP.

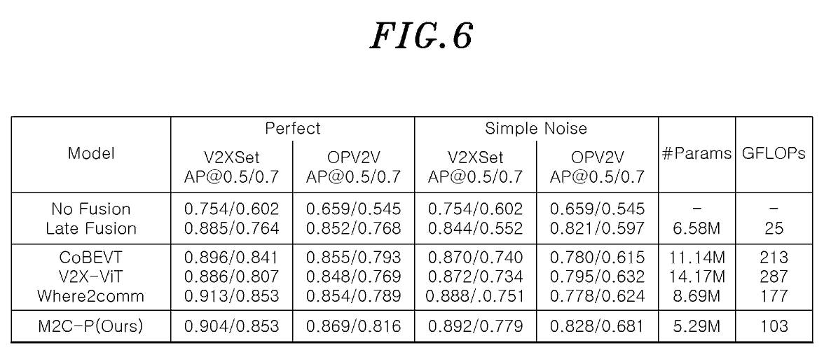

FIG. 6 is a diagram illustratively showing a comparison result of the performance of a deep learning model designed based on a parallel connection of cooperative perception modules according to an embodiment of the present invention and the performance of a conventional deep learning model.

Referring to FIG. 6, compared to the V2X-ViT technology developed in 2022, the number of parameters is decreased by approximately 58.1% and GFLOPs are decreased by 58.4%, performing efficient operations, and the accuracy performance is improved by up to 8.0%.

Furthermore, compared to the where 2comm technology developed in 2022, the number of parameters is decreased by 36.6% and GFLOPs are decreased by 32.2%, performing efficient operations, and the accuracy performance is improved by up to 3.6%.

Furthermore, compared to the CoBeVT technology developed in 2022, the number of parameters is decreased by 46.86% and GFLOPs are decreased by 51.64%, performing efficient operations, and the accuracy performance is improved by up to 10.73%.

The combinations of each block of the attached block diagrams and each step of the flowcharts may be performed by computer program instructions. These computer program instructions may be loaded onto an encoding processor of a general-purpose computer, a special-purpose computer, or other programmable data processing equipment, so that the instructions executed through the encoding processor of the computer or other programmable data processing equipment create means for performing the functions described in each block of the block diagrams or each step of the flowcharts. These computer program instructions may also be stored in a computer-usable or computer-readable memory that may direct a computer or other programmable data processing equipment to implement functions in a specific way, so that the instructions stored in the computer-usable or computer-readable memory may also produce an article of manufacture containing instruction means for performing the functions described in each block of the block diagrams or each step of the flowcharts. The computer program instructions may also be loaded onto a computer or other programmable data processing equipment, so that a series of operational steps are performed on the computer or other programmable data processing equipment to create a computer-executed process, so that the instructions that execute the computer or other programmable data processing equipment may also provide steps for executing the functions described in each block of the block diagrams and each step of the flowcharts.

Furthermore, each block or each step may represent a part of a module, segment, or code including one or more executable instructions for executing a specified logical function(s). It should also be noted that in some alternative embodiments, the functions mentioned in the blocks or steps may occur out of order. For example, two or more blocks or steps shown in succession may in fact be performed substantially simultaneously, or the blocks or steps may sometimes be performed in reverse order depending on the corresponding function.

The above description is merely an illustrative explanation of the technical idea of the disclosure, and various modifications and variations will be possible for those of ordinary skill in the art to which the disclosure pertains without departing from the essential quality of the disclosure. Therefore, the embodiments disclosed herein are not for limiting the technical idea of the disclosure but for explaining it, and the scope of the technical idea of the disclosure is not limited by these embodiments. The protection scope of the invention should be interpreted by the claims below, and all technical ideas within the equivalent scope should be interpreted as being included in the scope of rights of the invention.

What is claimed is:

1. A method for detecting an object based on a parallel connection of cooperative perception modules, the method comprising:
obtaining feature data from an ego agent, surrounding agents of the ego agent, and surrounding infrastructure facility of the ego agent; and
detecting the object in the ego agent based on a head that is output by inputting the feature data into a deep learning model designed based on the parallel connection of the cooperative perception modules.

2. The method of claim 1, wherein the obtaining the feature data includes:
acquiring first feature data to third feature data, respectively corresponding to first LiDAR point cloud data, second LiDAR point cloud data, and third LiDAR point cloud data from each agent based on communication among a first agent of the ego agent, a second agent of the surrounding agents, and a third agent of the surrounding infrastructure facility; and
determining the feature data for recognizing the object in the ego agent, based on sharing of the first feature data to the third feature data.

3. The method of claim 1, wherein the deep learning model includes:
a first cooperative perception module that identifies complementary information from features received from communication-capable agents;
a second cooperative perception module for recognizing global information about a driving space; and
a third cooperative perception module for recognizing local information about the driving space,
wherein the first cooperative perception module, the second cooperative perception module, and the third cooperative perception module are connected in parallel.

4. The method of claim 3, wherein the detecting the object includes:
outputting compressed feature data by inputting the feature data into a channel compression layer ; and
outputting the head by parallelly inputting the compressed feature data into the first cooperative perception module, the second cooperative perception module, and the third cooperative perception module,
wherein the outputting compressed feature data and the outputting the head are repeated for a predetermined number of iterations.

5. An apparatus for detecting an object based on a parallel connection of cooperative perception modules, the apparatus comprising:
a memory in which an object detection program is stored; and
a processor that loads the object detection program from the memory and executes the object detection program,
wherein the processor is configured to:
obtain feature data from an ego agent, surrounding agents of the ego agent, and surrounding infrastructure facility of the ego agent, and
detect the object in the ego agent based on a head that is output by inputting the feature data into a deep learning model designed based on the parallel connection of the cooperative perception modules.

6. The apparatus of claim 5, wherein the processor is configured to:
acquire first feature data to third feature data, respectively corresponding to first LiDAR point cloud data, second LiDAR point cloud data, and third LiDAR point cloud data from each agent based on communication among a first agent of the ego agent, a second agent of the surrounding agents, and a third agent of the surrounding infrastructure facility, and
determine the feature data for recognizing the object in the ego agent, based on sharing of the first feature data to the third feature data.

7. The apparatus of claim 5, wherein the deep learning model includes:
a first cooperative perception module that identifies complementary information from features received from communication-capable agents;
a second cooperative perception module for recognizing global information about a driving space; and
a third cooperative perception module for recognizing local information about the driving space,
wherein the first cooperative perception module, the second cooperative perception module, and the third cooperative perception module are connected in parallel.

8. The apparatus of claim 7, wherein the processor is configured to:
output compressed feature data by inputting the feature data into a channel compression layer , and
output the head by parallelly inputting the compressed feature data into the first cooperative perception module, the second cooperative perception module, and the third cooperative perception module,
wherein the outputting compressed feature data and the outputting the head are repeated for a predetermined number of iterations.

9. A non-transitory computer-readable storage medium storing a computer program, wherein the computer program, when executed by a processor, comprises instructions for causing the processor to perform an object detection method comprising:
obtaining feature data from an ego agent, surrounding agents of the ego agent, and surrounding infrastructure facility of the ego agent; and
detecting the object in the ego agent based on a head that is output by inputting the feature data into a deep learning model designed based on a parallel connection of cooperative perception modules.

10. The non-transitory computer-readable storage medium of claim 9, wherein the obtaining the feature data includes:
acquiring first LiDAR point cloud data, second LiDAR point cloud data, and third LiDAR point cloud data from each agent, respectively, based on communication among a first agent of the ego agent, a second agent of the surrounding agents, and a third agent of the surrounding infrastructure facility;
extracting first feature data to third feature data by inputting each of the first LiDAR point cloud data to the third LiDAR point cloud data into a feature extraction module; and
determining the feature data for recognizing the object in the ego agent, based on sharing of the first feature data to the third feature data.

11. The non-transitory computer-readable storage medium of claim 9, wherein the deep learning model includes:
a first cooperative perception module for recognizing information about communicable object;
a second cooperative perception module for recognizing global information about a driving space; and
a third cooperative perception module for recognizing local information about the driving space,
wherein the first cooperative perception module, the second cooperative perception module, and the third cooperative perception module are connected in parallel.

12. The non-transitory computer-readable storage medium of claim 11, wherein the detecting the object includes:
outputting compressed feature data by inputting the feature data into a channel compression layer ; and
outputting the head by parallelly inputting the compressed feature data into the first cooperative perception module, the second cooperative perception module, and the third cooperative perception module,
wherein the outputting compressed feature data and the outputting the head are repeated for a predetermined number of iterations.
